(19) United States
(12) Patent Application Publication
(10) Pub. No.: US 2011/0034325 A1
(43) Pub. Date: Feb. 10, 2011

(54) HIGH PERFORMANCE ORR (OXYGEN REDUCTION REACTION) PGM (PT GROUP METAL) FREE CATALYST

(75) Inventors: Stefano Catanorchi, Cascina (IT); Michele Piana, Mombaruzzo (IT)

Correspondence Address: GIFFORD, KRASS, SPRINKLE,ANDERSON & CITKOWSKI, P.C, PO BOX 7021, TROY, MI, 48007-7021, US

(73) Assignee: ACTA S.P.A., Crespina (IT)

(21) Appl. No.: 12/936,883

(22) PCT Filed: Apr. 6, 2009
(86) PCT No.: PCT/EP2009/054083

§ 371 Date: Oct. 7, 2010

(30) Foreign Application Priority Data
Apr. 7, 2008 (EP) 08006909.9

(51) Int. Cl. B01J 31/18

(52) U.S. Cl. 502/167

(57) ABSTRACT

Herein are disclosed PGM-free catalysts, made starting from transition metal phthalocyanine complexes, useful for catalytic ORR, and more particularly, alcohol tolerant catalysts as cathode material for ORR in alkaline and acid medium, characterized by low hydrogen peroxide generation and having better performance, stability and activity.

### FIELD OF THE INVENTION

The present invention relates to PGM-free catalysts useful in ORR and, more particularly, to electrocatalysts useful as cathode material for the electro-reduction of oxygen in fuel cells.

### BACKGROUND OF THE INVENTION

Fuel cells are electrochemical devices that convert the chemical energy of a reaction directly into electrical power. In such cells, a fuel (generally hydrogen, alcohols or saturated hydrocarbons) and an oxidant (generally oxygen from air) are fed in a continuous supply to the electrodes. Theoretically, a fuel cell can produce electrical energy for as long as the fuel and oxidant are supplied to the electrodes. In reality, degradation or malfunction of the components limits the practical operating life of fuels cells.

A variety of fuel cells are in different stages of development; considering, in particular, fuel cells in which electrocatalysts can be used, the following can be mentioned as examples: Polymer Electrolyte Fuel cells (PEFC) fuelled with H₂, Direct Oxidation Fuel Cells (DOFC) fuelled with alcohols (Direct Alcohol Fuel Cell, DAFC) or with any other hydrogen-containing liquid or gaseous fuel (alcohols, glycols, aldehydes, saturated hydrocarbons, carboxylic acids, etc), Phosphoric Acid Fuel Cells (PAFC) and Molten Carbonate Fuel Cells (MCFC). Fuel cells can employ both proton and anion exchange membranes.

According to the invention fuel cells include also metal-air batteries, since the metal-air batteries can be thought as fuel cell in which the fuel is the metal anodic material itself. Another possible electrochemical device which exploits the oxygen reduction reaction is the chlor-alkali electrolysis cell.

Essential components of any fuel cell of the types mentioned above are the electrodes that in general contain metals or metal particles supported on porous carbon materials bound to a suitable conductor. Catalysts usually employed for reducing the oxygen comprise transition metals, such as platinum, nickel, cobalt, silver, to mention but a few. Catalysts usually employed for oxidizing the fuel (for example H₂ in the PEFCs and methanol in the DMFC) are platinum, platinum-ruthenium, platinum-ruthenium-molybdenum and platinum-tin mixtures. The fuel cells usually contain platinum, alone or in conjunction with other metals, preferably ruthenium, at the anode, while the cathode is generally formed by platinum, yet other metals can be equally employed. The preferred presence of platinum, generally in high loadings, represents a major economic limitation to the mass production of fuel cells for transportation, cellular phones and electronic devices in general. Indeed, the high cost of platinum (currently, around 25-30 USD/g) contributes to make the cost of power produced by a fuel cell much greater than the cost of other power generation alternatives. Moreover, platinum-based cathodes in DMFC's are sensitive to cross-over of methanol. Given the higher efficiency of fuel cells as compared to traditional power generation devices as well as their environmentally benign nature, it is highly desirable to develop fuel cells that do not require platinum or PGMs.

### State of the Art

The macrocyclic N4-chelates of transition metals on porous carbon materials are among the potential candidates to replace Pt at the cathode side.

Macrocyclic N4-chelates showing the best activities for oxygen reduction are tetraphenyl-porphyrins (TPP), tetramethoxyphenyl-porphyrins (TMPP), dibenzotetra-azaannulenes (TAA), and the phthalocyanines (PC) of iron and cobalt.

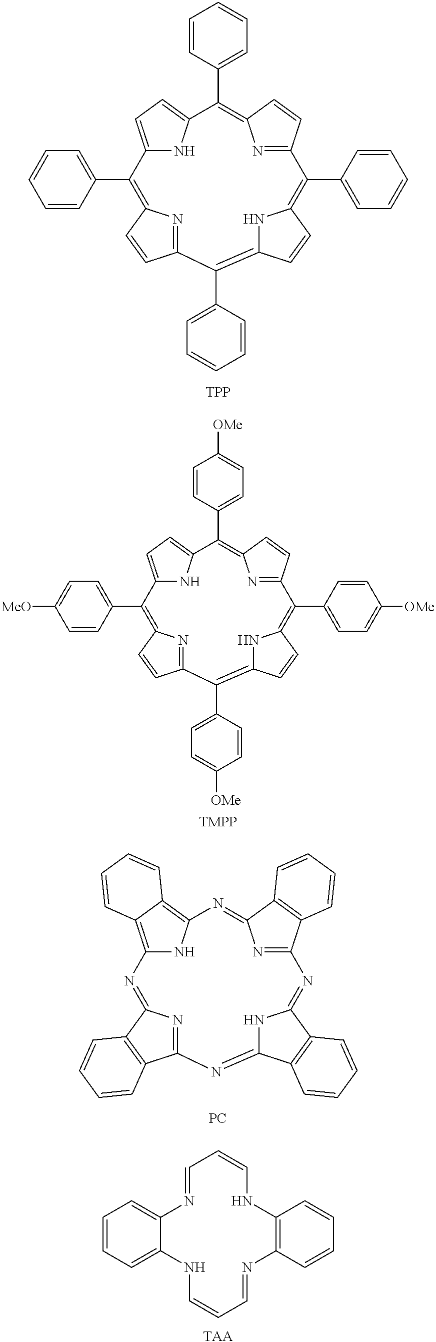

All these materials display an activity similar to that of Pt for the electro-reduction of O₂. However, they suffer from low electrochemical stability, and they decompose either via hydrolysis in the electrolyte or attack of the macrocycle ring by peroxide intermediates.

Several research groups have reported that the heat treatment of transition metal macrocycles adsorbed on high-area porous carbon supports greatly improves their stability as electrocatalysts for oxygen reduction without substantially degrading and, in some instances, enhancing their overall catalytic activity.

DE 102005 015572 describes a supported catalyst made from a electroconductive carbon support (Vulcan XC 72 R-Cabot) submitted to plasma treatment with a pressure of 0.1 mbar for 5 min under an argon oxygen gas mixture in the ratio 1:1 excited with an high frequency of 27.12 MHZ, then Ru (tpy) (pydic) is mixed to the activated coal in the mass ratio 1:5 and submitted to a plasma treatment again in a HF-plasma (27.12 MHZ) with a pressure of 0.1 mbar for 5 min treated. The process gas consists of argons.

WO 2005/69893 describes PGM catalysts comprising Pt, Pd and the like in combination with one transition metal selected in the group consisting of Fe, Co, Cr, and Ni, supported on a high surface area carbon. The catalysts are obtained by heat treatment and precursors of said transition metals are metal macrocyclic complexes such phtalocyanines. Therein is described a process for the preparation of such catalysts, said process comprising the step of dispersing a noble metal such as Pt on the support, then the metal macrocycle is also adsorbed onto the support, then heat treated.

JP 59090365 describes an electrode current-collector material such as graphite, acetylene black, active carbon or carbon fiber is mixed with an iron compound, urea and at least one compound selected from among pyromellitic dianhydride, pyromellitoamide and pyromellitonitrile.; As the above iron compound, a compound reacting with at least one of pyromellitic dianhydride, pyromellitoamide and pyromellitonitrile to produce an iron phthalocyanine polymer, such as ferrous chloride, ferric chloride or ferrous sulfate, is employed. Thus prepared mixture is subjected to reaction under an atmosphere of a nonreactive gas such as argon gas so as to synthesize an iron phthalocyanine polymer supported on the above electrode current-collector material, thereby obtaining an electrode material.

Contamin et al. (Electrochimica Acta 45 (1999), pp. 721-729) reports upon the preparation of a cobalt-containing electrocatalyst by pyrolysis of cobalt tetraazaannulene in the presence of active charcoal soot. When adding thiourea to the starter preparation, the authors observed a significant increase in the activity of the catalyst. The active center consists of two oppositely positioned cobalt atoms bonded to the carbon matrix by C—S-bridges.

H. A. Gasteiger et al. (Applied Catalysis B: Environmental 56, (2005), 9-35) reviews published PGM-free catalysts (pag. 29-33). For acid ORR some limited success on both stability and activity fronts has been achieved with a class of materials in which a transition metal ion, typically Fe or Co, is stabilized by several nitrogens bound into an aromatic or graphite-like carbon structure. The appropriate form of carbon has generally derived from polymerization (and often pyrolysis) of organic macromolecules akin to the prosthetic group of hemoglobin. Examples of such macrocycles catalysts are polymerized Fe phtalocyanine (FePC) and Co methoxytetraphenylporphirin (CoTMPP). The activity of such material has typically improved after heat treatments at temperatures sufficiently high to remove most of the hydrogen and much of the nitrogen from the macrocycle precursor, leading to an active site whose structure is not yet elucidated.

M. Lefevre et al. in J. Phys. Chem. B (2000) describe catalyst material for oxygen reduction in PEM fuel cells prepared starting from Fe<II> acetate as precursor compound mixed with perylene tetracarboxylic dianhydride (PTCDA) as organic compound in the presence of NH₃ as nitrogen precursor compound and is pyrolyzed at a high temperature in excess of 800[deg.] C. The polymerization of the metal and nitrogen-free PTCDA results in situ in a porous conductive carbon matrix into which individual iron atoms are adsorptively bonded as electron donors and as iron chelate coordinated by four nitrogen atoms. The essay reveals that the catalyst activity of the chelate catalyst material may be affected by way of the iron content and the temperature of the pyrolysis. However, this is insufficient for any commercial application which is based not least on the relatively low attained porosity. Furthermore, no adequate stability can be attained. Moreover, in the synthesis, a matrix former as well as a nitrogen donor separated therefrom, must be used in addition to the transition metal.

WO 03/004156 (US patent 2004/0236157 A1, H. Tributsch, P. Bogdanoff et al.) This patent describes the preparation of unsupported cathode catalyst by pyrolyzing a blend of thiourea, Co tetramethoxyphenylporphyrine (CoTMPP) (not phtalocyanine) and Fe oxalate. No conductive porous carbon material is used. Thiourea is used because gives a significant increase in the activity of the catalyst. Fe oxalate is used in large excess respect with CoTMPP and while Fe²⁺ acts as electron donor for the active Co—N₄ cores oxalate is used as a foaming agent because during pyrolysis it decomposes with generation of gas, thus acting as a nano-pore filler material during the polymerization of the Co TMPP. The resulting highly porous carbon matrix is therefore formed in situ and contributes to an increase to the catalyst activity by an enlargement of the active surface. A small portion of Fe derived from Fe oxalate during the synthesis remains bonded to the carbon matrix, the largest portion serves during in situ production of the carbon matrix as nano-pore forming filler material and following their formation are washed out in the acid treatment (boiling in 1N HCl under argon for 30 min) of the process for the preparation of the catalyst. This catalyst shows an activity almost identical to a conventional standard Pt cathode catalyst.

U.S. Pat. No. 6,245,707 B1 disclosed methanol tolerant catalyst materials and a method of making the same are provided. These catalyst materials were obtained by mixing together and heat-treating at least two different transition-metal-containing nitrogen chelates. The nitrogen chelates comprise metalloporphyrins such as transition-metal-containing tetraphenylporphins. Preferred transition metals are iron, cobalt, nickel, copper, manganese, ruthenium, vanadium, and zinc, but could be any transition metal other than platinum or palladium. These materials offer improved catalytic oxygen reduction in the presence of methanol, as may occur at a fuel cell cathode after methanol crossover.

Sawai, K. et al. Electrochem. 75 (2007) 163 discloses Platinum-free air cathode supported catalysts prepared by heat-treating transition metal hexacyanometallate precursors under an inert atmosphere. The catalytic activity for oxygen reduction was examined with the floating electrode and rotating ring-disk electrode techniques. Among several Pt-free catalysts based on 3d-transition elements, catalysts containing cobalt or copper in combination with iron exhibited high activity toward oxygen reduction, and the catalyst containing copper and iron showed very low generation of hydrogen peroxide during oxygen reduction.

Activities of different metallomacrocyclics for the reduction of O₂ were compared in Zagal, J. H.; et al. “Linear versus volcano correlations between electrocatalytic activity and redox and electronic properties of metallophthalocyanines”, Electrochimica Acta 44 [1998] 1349-1357. It was observed for Co(III)/Co(II) phtalocyanine that redox potentials shift to more positive values due to the electron-withdrawing effect of the fluoro substituent compared to unsubstituted CoPC.

Although much effort has been devoted to determine the composition and the structure of the electrocatalytic center that is formed upon pyrolysis, some controversies still exist and a number of various hypotheses have been put forward to explain the increased activity and stability of the pyrolyzed material:
Formation of a highly active carbon with functional chemical surface groups. In this hypothesis, the transition metal atoms are not directly responsible for the increased oxygen reduction capability but instead catalyze the formation of the highly active carbon surface;
Retention of the metal-N4 active site structure even after the pyrolysis treatment.
Formation of a modified carbon surface on which transition metal ions are adsorbed, principally through interactions with the residual nitrogen derived from the heat-treated macrocycles.

In view of the above said it is evident the necessity of making available new PGM-free catalysts endowed of higher performance. Objective of the present invention is to provide PGM free catalysts useful for catalytic ORR, and more particularly, alcohol tolerant catalysts as cathode material for ORR, in alkaline and acid medium, having better performance, higher stability and activity and showing low hydrogen peroxide generation. Object of the invention is at least to provide alternative PGM free catalysts.

### SUMMARY OF THE INVENTION

Object of the present invention are supported catalysts obtained by heat treating a blend of FePC, MePC, a compound containing sulfur and nitrogen and a electronic conducting porous carbon support, wherein Me is Co or Cu.

Further object of the present invention is a process for preparing the above supported catalysts said process comprising the steps of firstly adsorbing the metal PCs together with the compound containing sulfur and nitrogen on the carbon support and then pyrolysing the obtained blend.

Further object of the invention is the use of said catalysts for catalytic ORR.

The catalysts of the invention are a novel family of Fe—Co or Fe—Cu containing supported catalysts obtained from a novel combination of known starting materials submitted to heat treatment. Surprisingly said catalyst showed very good performances as ORR catalyst both in acid and alkaline medium.

Other advantages of the invention are reported below in the description.

### BRIEF DESCRIPTION OF THE DRAWINGS

FIG. 1 represents schematically a preferred process of preparation of the catalysts according to the invention.

FIG. 2 shows the RDE cyclic voltammograms of Fe/Cu and Fe/Co catalysts of the invention and Pt/C in alkaline medium.

FIG. 3 shows the data from FIG. 2 corrected for the ohmic drop due to the resistance within the cell.

FIG. 4 shows the ORR kinetic current in RDE test for Fe/Cu and Fe/Co catalysts of the invention and Pt/C

FIG. 5 shows the data from FIG. 4 corrected for the ohmic drop due to the resistance within the cell.

FIG. 6 shows the peroxide production obtained with the catalyst of the invention from Rotating Ring Disk Electrode analysis.

FIG. 7 shows the RDE cyclic voltammograms of Fe/Cu and Fe/Co catalysts of the invention and Pt/C in acidic medium.

FIG. 8 shows selectivity of the catalysts of the invention and Pt/C in presence of 2.55 M EtOH

### LIST OF ABBREVIATIONS

### DAFC Direct Alcohol Fuel Cell

### DOFC Direct Oxidation Fuel Cells

### MCFC Molten Carbonate Fuel Cells

### ORR Oxygen Reduction Reaction

### PAFC Phosphoric Acid Fuel Cells

PC phthalocyanine

### PEFC Polymer Electrolyte Fuel Cells

### PGM Platinum Group Metal

### RDE Rotating Disk Electrode

### DETAILED DESCRIPTION OF THE INVENTION

The catalysts of the present invention were prepared by heat treating blends comprising:
a) a Fe phthalocyanine (PC) of formula (I)

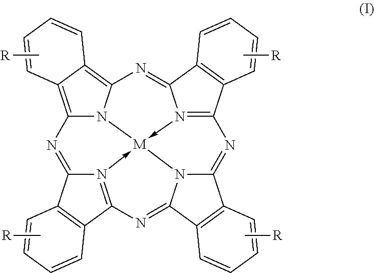

wherein
M is Fe²⁺, Fe³⁺
R is hydrogen or an electron-withdrawing substituent
wherein when M=Fe³⁺ a counterion X⁻ is present
b) a transition metal phthalocyanine (Metal-PC) of formula (II)

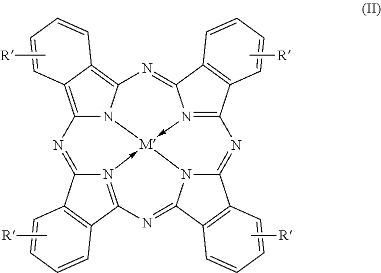

wherein
M′ is Cu²⁺ or Co²⁺
R′, independently from R, is hydrogen or an electron-withdrawing substituent
c) a compound containing nitrogen and sulfur
d) an electronic conducting porous carbon material

According to the invention the heat treatment is performed at a temperature and time enough to firstly polymerize and then at least partially pyrolize the PCs, therefore the heat treatment is for example in the range 350-900° C. for at least 0.5 hours. The heat treatment is an essential step during which the catalytic metals are anchored and/or alloyed onto the high surface area carbon support.

Electron-withdrawing substituents according to the invention are for example: halogen, —NO₂, —SO₃H, alkylsulphonyl, arylsulphonyl, —COOH, alkylcarboxyl, cyanide, alkylcarbonyl, arylcarbonyl.

Counterion X⁻ according to the invention is for example chloride, bromide or any other anion of a monoprotic acid.

The compound c) containing nitrogen and sulfur according to the invention is that wherein the sulfur has oxidation state −2, such as thiourea, ammonium thiocyanate, thioacetamide and isothiocyanate and their salts or derivatives. Electronic conducting porous carbon materials according to the invention are high surface area material for example: electroconductive carbon black such as Ketjen Black, Vulcan XC-72R and acetylene black; carbon for ink treated with an oxidizing agent, pyrolytic carbon, natural graphite, artificial graphite.

Said carbon support has a surface area higher than 1200 cm²/g; preferably a surface area equal or higher than 1400 cm²/g.

According to the invention the molar ratio between the chosen Metal-PC and the FePC is preferably comprised between 1.1 to 1.4, more preferably is 1.2, and said organic compound ranges from 0.4 to 0.6, preferably 0.5, molar ratio in respect of the FePC+Metal-PC. The carbon support is present in the mixture in quantity 2.0-3.0 g/mmol of FePC, preferably 2.5 g/mmol of FePC

The combination Fe—Cu is preferred.

Among the porous carbon material Ketjen Black is preferred, while among the organic compounds thiourea is preferred.

According to the invention said catalysts are preferably prepared with the following process:
components a, b, c and d are dispersed in an organic solvent and the resulting slurry is eventually sonicated
the solvent is removed by evaporation
the obtained blend is submitted to heat treatment
thereafter the final product is collected

The heat treatment is performed at a temperature and time enough to firstly polymerize and then at least partially pyrolize the PCs, therefore the heat treatment is for example in the range 350-900° C. for at least 0.5 hours. In a preferred embodiment the heat treatment is a two step pyrolysis sequentially at the following temperature <500° C. and then >700° C.

In particular said two step pyrolysis is performed as following:
1. heating at 400-450° C. for at least 0.5-1 hour
2. heating at 750-800° C. for at least 1.5-2 hours

According to the invention said slurry is preferably left under stirring for 12-36 hours at 20-25° C. and then preferably sonicated for at least 30 minutes.

The organic solvent is normally chosen, for example, among: methanol, ethanol, propanol, isopropanol, tetrahydrofurane (THF), dimethylformamide (DMF), dimethylacetamide (DMA); preferably the organic solvent is ethanol which allowed to obtain a better dispersion of the starting materials and a final catalyst characterized by higher performance. Moreover ethanol is volatile and can be easily removed and is non toxic and easily available.

According to the most preferred embodiment of the invention the catalyst was prepared by a two steps pyrolysis of a mixture composed of Ketjen Black and thiourea/CoPC/FePC in molar ratio 1.1/1.2/1.0 or a mixture composed of Ketjen Black and thiourea/CuPC/FePC in molar ratio 1.1/1.2/1.0. Ketjen Black is present in the mixture in quantity of 2.5 g/mmol of FePC.

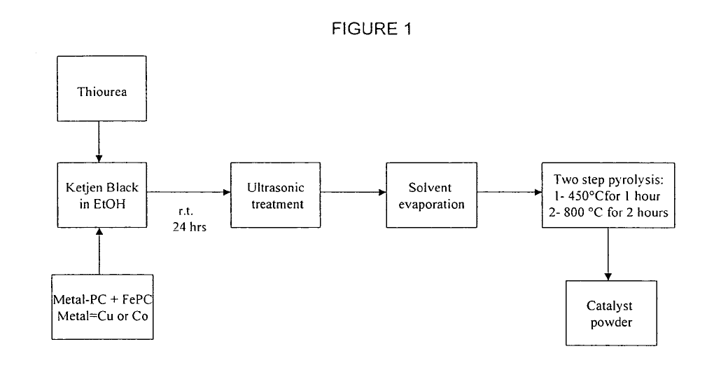

The process of preparation of the catalysts according to the invention is summarized under FIG. 1. This process is a one-pot process characterized by simple operations, reliable and reproducible also at larger scale. It employs cheap starting materials since metal complexes of PC are more readily and cheaply available then other N4-macrocyclic metal complexes.

The catalysts of the invention have been found to be advantageously used as cathode catalysts for catalytic ORR, particularly useful in fuel cells both in acid and alkaline medium; they resulted characterized by low hydrogen peroxide generation and having better performance, stability and activity of other catalysts known in the art. The higher performances are readily notable by comparison with commercial Pt/C catalysts that are used as standard reference. The so obtained new catalysts, in particular Fe—Cu catalysts of the invention, have a kinetic current higher, at every potential in the kinetic range, particularly in alkaline medium, than Pt/C and those known in the art.

The catalyst of the invention are alcohol tolerant and characterized by low hydrogen peroxide generation.

### Experimental Section

### Preparation of Metal-PC/FePC Catalyst

FePC and Metal-PC were purchased and used as received.

To slurry of 300 ml of EtOH and 20 gr. of Ketjen Black EC600JC, 7.9 mmoles of FePC, 9.6 mmoles of Metal-PC and 0.665 gr. of thiourea (8.75 mmoles), were added under vigorous stirring. The mixture was stirred, at room temperature, for 24 h and after sonicated for ½ h.

The solvent was evaporated and the solid so obtained (about 26.6 gr.) was heat treated in a quartz tube, under Ar flux, in two pyrolysis steps; the first at 450° C. for 1 h and the second at 800° C. for 2 h. The final product obtained is 24-27 g of a black powder.

Following the above procedure the following exemplifying catalysts were prepared:

| Example # | M | R | X— | M′ | R′ |
|---|---|---|---|---|---|
| 1 | Fe³⁺ | H | Cl⁻ | Cu²⁺ | H |
| 2 | Fe³⁺ | H | Cl⁻ | Co²⁺ | H |
| 3 | Fe²⁺ | H | none | Cu²⁺ | H |
| 4 | Fe²⁺ | H | none | Co²⁺ | H |

The ORR catalysts so obtained were submitted to electrochemical analysis.

### Electrochemical Analysis in Alkaline Medium:

The electrochemical analyses were carried out in 0.1 M KOH for example catalysts 1 and 2 and a commercial 10% Pt on Vulcan XC-72R. The inks are prepared using the binder-ionomer from Tokuyama (A3, 5 wt %) with the same recipe for all the catalysts. The ionomer to carbon weight ratio was 0.175.

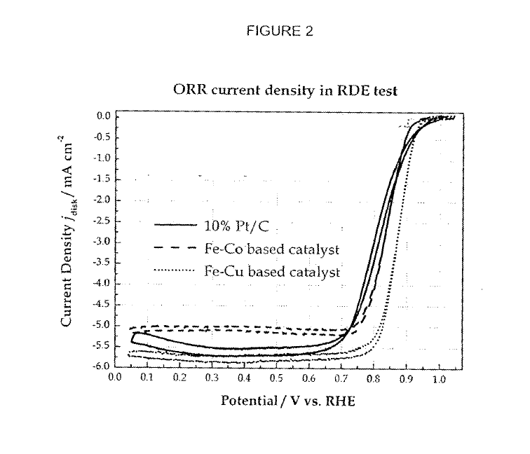

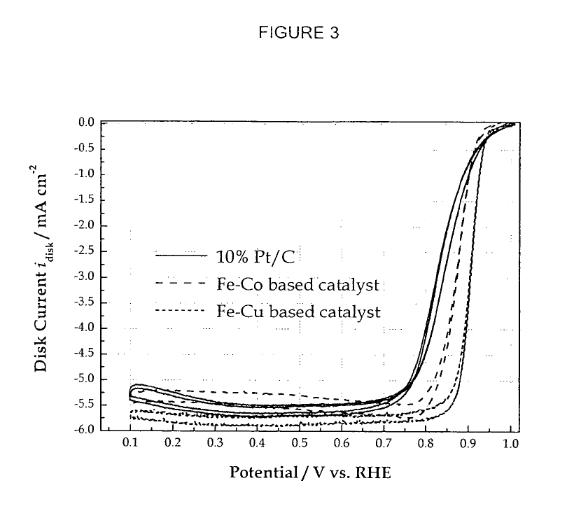

In FIG. 2 the Rotating Disk Electrode cyclic voltammograms of the three catalysts are shown. The real reference electrode used was Ag/AgCl in saturated KCl and it was calibrated using hydrogen redox reaction on Pt (saturated hydrogen solution); the calibration gives the equation for the conversion between the real E_{Ag/AgCl} and E_{RHE} (E_{RHE}=E_{Ag/AgCl}+0.919 V). From the curves in FIG. 2 is possible to get the kinetic parameters for the catalysts prepared as in example 1 and 2 and Pt/C. TABLE 1 shows the experimental parameters and ORR kinetic activity of the catalysts in oxygen saturated 0.1 M KOH. The parameter jₖ at 900 mV vs. Reversible Hydrogen Electrode is the current density corrected for mass transport, namely kinetic current density. FIG. 3 shows the data from FIG. 2 after the correction for the ohmic drop due to the resistance within the cell. This correction leads to an increase in the absolute activity of the catalyst.

TABLE 1
RDE experimental and ORR activity in 0.1 M KOH at 900 mV vs RHE, 5 mV/s, 1600 rpm, 25° C., pure O₂.

| | Catalyst | Metal | Carbon | Layer | i_{900 mV} | jₖ, _{900 mV} | | | |
|---|---|---|---|---|---|---|---|---|---|
| | loading | loading | Loading | thickness | vs. RHE | vs. RHE | iₖ | iₖ | iₖ |
| Catalyst | mg/cm² | μg_{M}/cm² | mg_{C}/cm² | μm | mA | A/cm² | A/mg_{catalyst} | A/mg_{Pt} | A/cm³ |
| 10% Pt/C | 0.33 | 33 | 0.29 | 8.4 | 0.17 | 1.0 | 0.0031 | 0.030 | 1.2 |
| Fe—Co | 0.34 | 11 | 0.33 | 10 | 0.15 | 0.88 | 0.0026 | — | 0.91 |
| Fe—Cu | 0.34 | 11 | 0.33 | 10 | 0.37 | 2.8 | 0.0082 | — | 2.9 |

TABLE 2 shows the activity parameter taken from various data collection, taking into account the correction of the ohmic drop within the cell. Using all the data collected it is possible to get some statistics on the activity. The correction is proportional to the current so it affects more the catalysts with higher activity. It means that the Fe—Cu based catalyst is even more active after the correction for the uncompensated resistance, while Pt and Fe—Co based catalyst do not change so much in activity.

TABLE 2
Results from RDE and RRDE analysis, ORR mass-transport corrected
specific currents obtained in 0.1 M KOH at 900 mV vs. RHE at
25° C., 5 mV/s and 1600 rpm using pure oxygen. This values
are corrected for the uncompensated resistance within the cell.

| | iₖ | iₖ | | iₖ |
|---|---|---|---|---|
| Catalyst | mA/mg_{catalyst} | mA/mg_{Pt} | mg_{cat}/cm³ | A/cm³ |
| 10% Pt/C | 4.0 ± 1.2 | 40 ± 12 | 400 | 1.6 ± 0.5 |
| Fe—Co | 2.4 ± 1.2 | — | 370 | 0.9 ± 0.4 |
| Fe—Cu | 23 ± 8 | — | 375 | 8.7 ± 3.0 |

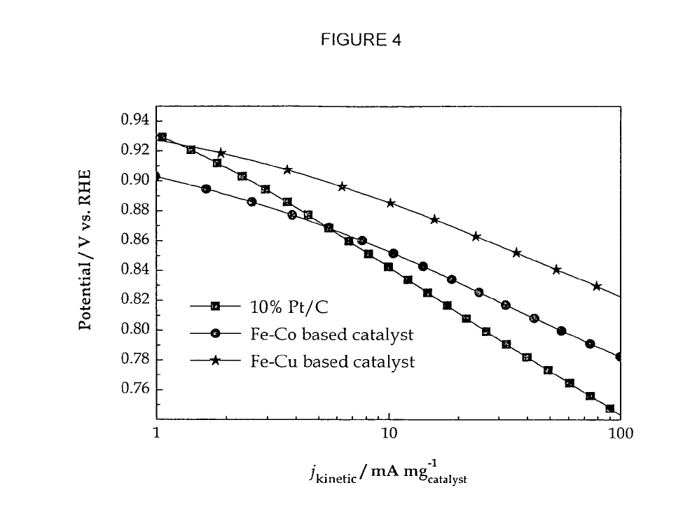

In FIG. 4 the electrode potential as a function of RDE kinetic current are shown for the three catalysts. From this plot it is evident that the catalysts of the invention provide higher kinetic currents than Pt commercial catalysts at the same overpotential. From the curves graph in FIG. 3 is possible to measure the overpotential decrease as a function of kinetic current in the case of the new Fe/Cu based catalyst with respect to Pt/C catalyst, obtaining an overvoltage decrease from 10 mV at 2 mA/mg_{catalyst} (0.66 mA/cm²) to 45 mV at 10 mA/mg_{catalyst} (3.3 mA/cm²) and 83 mV at 100 mA/mg_{catalyst} (33 mA/cm²). In the case of Fe/Co based catalyst the comparison with Pt/C catalyst, obtaining an overvoltage increase of 10 mV at 2 mA/mg_{catalyst} (0.66 mA/cm²) and an overvoltage decrease of 20 mV at 10 mA/mg_{catalyst} (3.3 mA/cm²) and 43 mV at 100 mA/mg_{catalyst} (33 mA/cm²).

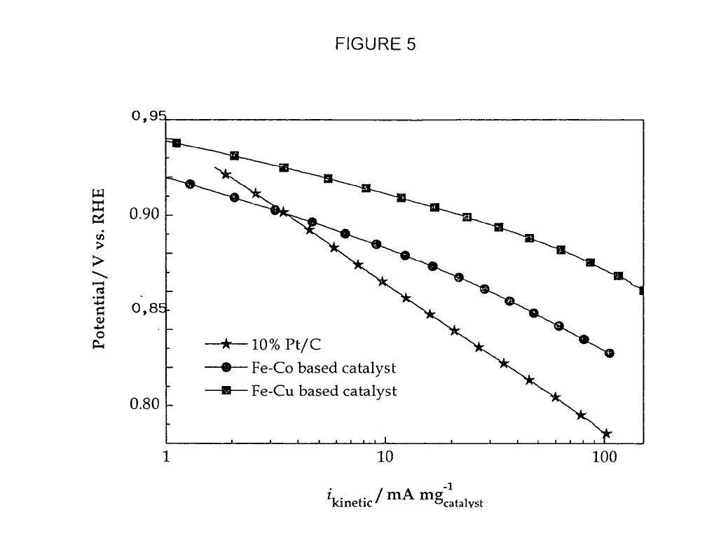

In FIG. 5 the data from FIG. 4 are corrected for the ohmic drop due to the resistance within the measurement cell. The correction does not change substantially the variation in overvoltage between the catalysts.

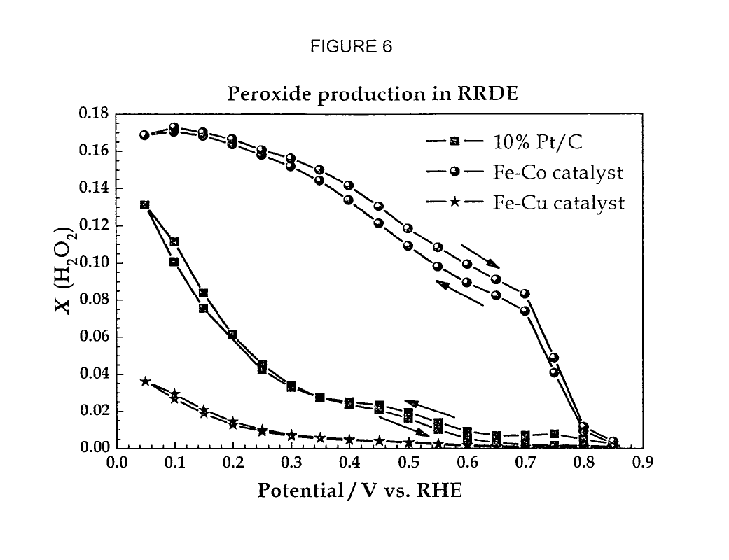

FIG. 6 shows the peroxide production obtained from Rotating Ring Disk Electrode analysis (0.33 mg_{cat}/cm². 25° C., 0.1 M KOH, 1600 rpm, pure O₂); it is evident how the peroxide production is higher than Pt for Fe—Co based catalyst while is lower for Fe—Cu based catalyst. This will be an advantage for the durability because peroxide is a very reactive species and can damage the components of the device in which the catalyst is applied, most of all a polymer membrane where present.

### Electrochemical Analysis in Acidic Medium:

The activity of the catalyst of the invention has been measured in acid medium in comparison with Pt 10 wt % on Vulcan. The electrochemical analyses were carried out in 0.1 M H₂SO₄ on Fe—Cu based, Fe—Co based as prepared in example 1 and 2 and a commercial 10 wt % Pt on Vulcan XC-72R. The inks are prepared using the Nafion ionomer (5 wt %) with the same recipe for all the catalysts. The ionomer to carbon weight ratio was 0.175.

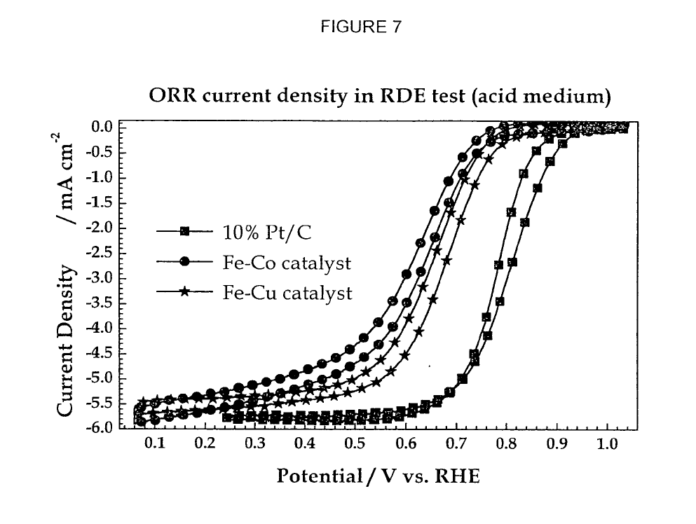

In FIG. 7 are shown the Rotating Disk Electrode cyclic voltammograms of the three catalysts (O₂ saturated electrolyte: 0.1 M H₂SO₄; scan rate: 5 mV s⁻¹; rotation rate: 1600 rpm; electrode area: 0.196 cm²). The real reference electrode used was Ag/AgCl in saturated KCl and it was calibrated using hydrogen redox reaction on Pt (saturated hydrogen solution); the calibration gives the equation for the conversion between the real E_{Ag/AgCl} and E_{RHE} (E_{RHE}=E_{Ag/AgCl}+0.243 V).

From the curves in FIG. 7 is possible to measure the overpotential differences between the new Fe—Cu based catalyst, Fe—Co based catalyst and Pt/C, obtaining an overvoltage increase of 130 mV for Fe—Cu and 160 mV for Fe—Co. This is a result better in activity than the state of the art non-noble metal catalysts in acid medium (F. Jaouen et al. J. Phys Chem. B 2003, 107, 1376).

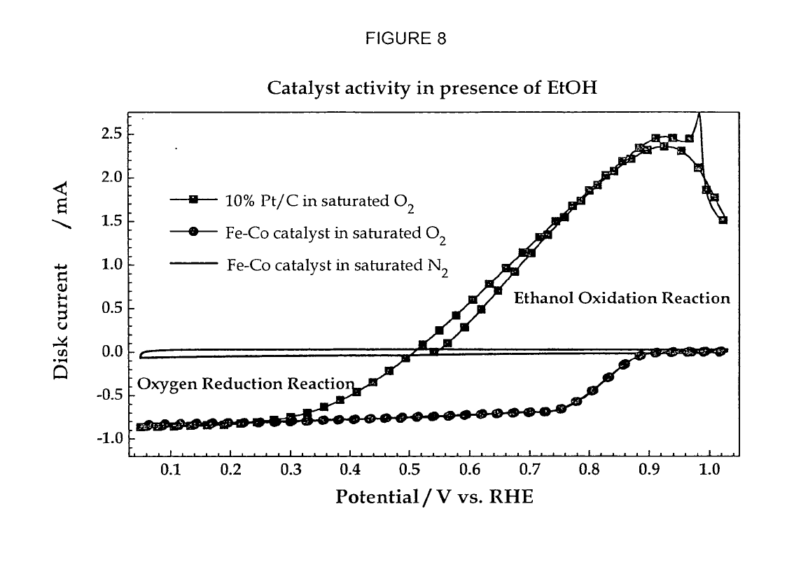

In FIG. 8 is shown the catalytic activity in presence of 2.55 M EtOH(O₂ saturated electrolyte: 0.1 M H₂SO₄; scan rate: 5 mV s⁻¹; rotation rate: 1600 rpm; electrode area: 0.196 cm²). From the curves in FIG. 8 is evident the difference in selectivity between the catalyst of the invention and 10 wt % Pt/C. In presence of 2.55 M EtOH the Pt catalyst is active for ethanol oxidation reaction in oxygen saturated solution while Fe—Co catalyst is completely inactive for ethanol oxidation reaction as shown in the solution saturated with N₂.

From the comparison between the diffusion limited currents of non-PGM catalysts of the invention and commercial 10 wt % Pt/C we have strong clues of the complete oxygen reduction to hydroxide ions pathway (the 4 electrons mechanism), with low hydrogen peroxide production; this is because the diffusion limited currents are always close to each other, both in alkaline and acid medium, and is well known that Pt provides 4 electrons.

1-15. (canceled)

16. A catalyst material obtained by heat treating blends comprising:
a) a Fe phthalocyanine (PC) of formula (I) 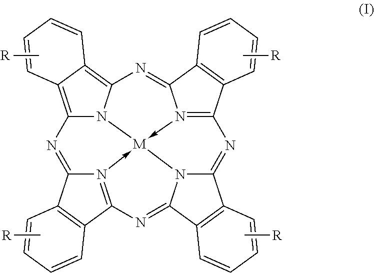
wherein
M is Fe²⁺, Fe³⁺
R is hydrogen or an electron-withdrawing substituent;
wherein when M=Fe³⁺ a counterion X⁻ is present; 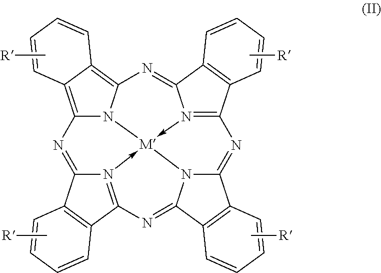
b) a transition metal phthalocyanine (Metal-PC) of formula (II)
wherein
M′ is Cu²⁻ or Co²⁺
R′, independently from R is hydrogen or an electron withdrawing substituent;
c) a compound containing nitrogen and sulfur;
d) an electronic conducting porous carbon material.

17. A catalyst according to claim 16 wherein said heat treatment is in the range 350-900° C. for at least 0.5 hours.

18. A catalyst according to claim 17 wherein said heat treatment is a two step pyrolysis performed sequentially with a first step at a temperature lower than 500° C. and then a second step at a temperature higher than 700° C.

19. A catalyst according to claim 18 wherein said two step pyrolysis includes the first step of heating at 400-450° C. for at least 0.5-1 hour and the second step of heating at 750-800° C. for at least 1.5-2 hours.

20. A catalyst according to claim 16 wherein:
said components a) and b) are those in which R and R′ are independently hydrogen or an electron-withdrawing substituent selected from halogen, —NO₂, —SO₃H, alkylsulphonyl, arylsulphonyl, —COOH, alkylcarboxyl, cyanide, alkylcarbonyl and arylcarbonyl; said counterion X⁻ (if present) is chloride or bromide; said organic compound c) containing nitrogen and sulphur is selected from thiourea, ammonium thiocyanate, thioacetamide, isothiocyanate and their salts or derivatives.

21. A catalyst according to claim 17 wherein the electronic conducting porous carbon materials d) is selected from Ketjen Black, Vulcan XC-72R, acetylene black, carbon for ink treated with an oxidizing agent, pyrolytic carbon, natural graphite and artificial graphite.

22. A catalyst according to claim 21 wherein said organic compound c) is thiourea, and said electronic conducting porous carbon materials d) is Ketjen Black.

23. A catalyst according to claim 16 wherein the molar ratio between the chosen Metal-PC and the FePC is between 1.1 to 1.4.

24. A catalyst according to claim 22 wherein the molar ratio between the chosen Metal-PC and the FePC is comprised between 1.1 to 1.4.

25. A catalyst according to claim 24 wherein the carbon support is present in quantity 2.0-3.0 g/mmol of FePC and the molar ratio of the organic compound ranges from 0.4 to 0.6 in respect of the FePC+Metal-PC.

26. A catalyst material according to claim 24 composed of a mixture of Ketjen Black 2.5 g/mmol of FePC and thiourea/Metal-PC/FePC in molar ratio 1.1/1.2/1.0 and prepared by a two steps pyrolysis performed as following:
i. heating at 400-450° C. for at least 0.5-1 hour;
ii. heating at 750-800° C. for at least 1.5-2 hours.

27. A process for the preparation of a catalysts material according to claim 16 comprising the steps of:
dispersing components a, b, c and d in an organic solvent and sonicating the resulting slurry;
removing the solvent by evaporation forming a blend; and
heat treating the blend forming a final product.

28. A process according to claim 27 wherein said heat treatment is a two step pyrolysis performed as following:
1. heating at 400-450° C. for at least 0.5-1 hour; and
heating at 750-800° C. for at least 1.5-2 hours.

29. A process according to claim 28 wherein said slurry is left under stirring for 12-36 hours at 20-25° C. and then is sonicated for at least 30 minutes and the organic solvent is selected from methanol, ethanol, propanol, isopropanol, THF, DMF, and DMA.

30. Use of a catalyst according to claim 16 as a catalyst for ORR occurring at a cathode of an electrochemical device.

31. Use of a catalyst according to claim 30 wherein the ORR occurs in alkaline medium.

32. Use of a catalyst according to claim 31 wherein the electrochemical device is an anion-exchange membrane fuel cell or an alkaline metal-air battery.

33. Use of a catalyst according to claim 30 wherein the ORR occurs in acidic medium.

34. Use of a catalyst according to claim 33 wherein the electrochemical device is a proton-exchange membrane fuel cell.
